(19) United States
(12) Patent Application Publication
(10) Pub. No.: US 2023/0021233 A1
(43) Pub. Date: Jan. 19, 2023

(54) GENERATION OF PERSONALIZED RECOMMENDATIONS

(71) Applicant: Huawei Technologies Co., Ltd., Shenzhen (CN)

(72) Inventors: Muhammad AMMAD-UD-DIN, Helsinki (FI); Suleiman ALI KHAN, Helsinki (FI); Adrian FLANAGAN, Helsinki (FI); Kuan Eeik TAN, Helsinki (FI)

(21) Appl. No.: 17/945,332

(22) Filed: Sep. 15, 2022

Related U.S. Application Data
(63) Continuation of application No. PCT/EP2020/057116, filed on Mar. 16, 2020.

(51) Int. Cl. G06Q 30/02; G06Q 30/06

(52) U.S. Cl. CPC G06Q 30/0205; G06Q 30/0201; G06Q 30/0631

(57) ABSTRACT

There is provided a client adapted for generating personalized cold-start federated recommendations for a user of the client. The client generates personalized recommendations for three cold-start scenarios, namely i) recommendation of an item to a new user which does not have any history of user-item interactions, ii) recommendation of a new item to a set of the most prospective users where the item has no history, and iii) recommendation of a new item to a new user, where there is no history associated with either the user or the item. The client uses a federated multi-view matrix factorization method to generate cold-start recommendations without transferring users' personal data to a remote server. Further, a server and a content provider for assisting in generating the personalized cold-start recommendations are provided in a federated set-up according to some aspects.

### CROSS-REFERENCE TO RELATED APPLICATIONS

This application is a continuation of International Application No. PCT/EP2020/057116, filed on Mar. 16, 2020, which is hereby incorporated by reference in its entirety.

### TECHNICAL FIELD

The present application relates to the field of information technology, and more particularly to recommendation systems.

### BACKGROUND

In recommendation services, new users may be continuously joining at a substantial pace. In order to ensure user retention, the new users must be provided top-quality service with personalized recommendations that hit the mark for every user.

In addition, every recommendation service has new content being added to it at a regular interval. For example, videos and applications may have a continuously increasing portfolio of items that the users can watch. A strong progression for a new item depends heavily on the first days and weeks of its addition to the service.

Both of the above example cases are classical cases of a so-called “cold-start” user-item recommendation with zero history of user-item interactions. Technically, the goal in cold-start recommendation may be to i) recommend an item to a new user which does not have any history of user-item interactions, and ii) recommend a new item to a set of the most prospective users where the item has no history on a platform. In addition, the iii) most challenging case is to identify if a new video should be recommended to a new user, where there is no history associated with either the user or the video.

Cold-start recommendations are fundamentally valuable for recommendation services. However, existing cold-start recommendation systems may require personal data of a user to be sent to a centralized server. This raises major privacy concerns. For example, with the European Union's General Data Protection Regulation directive, personal data (such as location, gender, demographics) cannot be moved out of the users' client devices. Therefore, there is a need for a system that is able to make cold-start user-item recommendations without the user's personal data moving out of his device.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

It is an objective to provide a solution for generating personalized item recommendations for a user of a client also in various cold-start situations. A client, a server, a content provider, a system and methods for providing personalized item recommendations for the user of the client are provided.

This objective is achieved by the features of the independent claims. Further embodiments and examples are apparent from the dependent claims, the description and the figures.

According to a first aspect, there is provided a client adapted for generating personalized recommendations of a new item for a user of the client. The client is connectable to a server comprising master model matrices Q, U for distribution to a plurality of clients for generating personalized item recommendations, wherein the personalized item recommendations are generated using a joint model of integrated multiple data views comprising a user-item interaction matrix R=PQ^{T}, a user data matrix X=UP^{T}, and an item data matrix Y=QV^{T}, wherein the matrices Q, V comprise latent variables relating to item meta data and the matrices P, U comprise latent variables relating to user personal data, the client being configured to retrieve a local data set x stored on the client; obtain an updated master model matrix Q_{v*} from the server, the master model matrix Q being updated in response to a new item; update a local model P based on the updated master model matrix Q_{v*} and the local data set x; and generate a personalized recommendation for the new item for the user of the client using the local model P and the updated master model matrix Q_{v*}. This enables that personalized item recommendations may be provided for the user of the client. The personalized item recommendations may be provided in a case, where a new item is added to a service or a platform without any historical data on user-item interactions. Further, no personal data of the user may need to be transmitted outside the client.

In one embodiment, the client is further configured to obtain the master model matrices Q, U from the server; and update the local model P based on the master model matrices Q, U and the local data set x. Hence, the personalized item recommendation may be generated using latest parameter updates from the master model matrices.

In one embodiment, the client is further configured to calculate gradient matrices dqₓ and dux of the master model matrices Q, U based on the local data set x and the local model P; transmit the gradient matrices dqₓ, duₓ to the server for enabling the server to generate aggregated gradient matrices dq, du based on gradient matrices received from the plurality of clients and at least one content provider, the aggregated gradient matrices dq, du enabling updating the master model matrices Q, U by the server; obtain updated master model matrices Q, U from the server; and update the local model P based on the updated master model matrices Q, U and the local data set x. Hence, that the master model matrices Q, U may be trained with parameter gradients received from the plurality of other clients. This enables that more accurate personalized item recommendations may be provided.

According to a second aspect, there is provided a client adapted for generating personalized item recommendations for a new user of the client, the client being connectable to a server comprising master model matrices Q, U for distribution to a plurality of clients for generating personalized item recommendations, wherein the personalized item recommendations are generated using a joint model of integrated multiple data views comprising a user-item interaction matrix R=PQ^{T}, a user data matrix X=UP^{T}, and an item data matrix Y=QV^{T}, wherein the matrices Q, V comprise latent variables relating to item meta data and the matrices P, U comprise latent variables relating to user personal data. The client is configured to retrieve a local data set x associated with the new user stored on the client; obtain the master model matrices Q, U from the server; generate a local model P_{x*} using the local data set x and the master model matrix U; and generate a personalized item recommendation for the new user of the client using the local model P_{x*} and the master model matrix Q. This enables that personalized item recommendations may be provided to a new user of a client. The personalized item recommendations may be provided in a case, for example, when a new user signs up to a service without any historical data on user-item interactions. Further, no personal data of the user may need to be transmitted outside the client.

According to a third aspect, there is provided a client adapted for generating personalized recommendations of a new item for a new user of the client. The client is connectable to a server comprising master model matrices Q, U for distribution to a plurality of clients for generating personalized item recommendations, wherein the personalized item recommendations are generated using a joint model of integrated multiple data views comprising a user-item interaction matrix R=PQ^{T}, a user data matrix X=UP^{T}, and an item data matrix Y=QV^{T}, wherein the matrices Q, V comprise latent variables relating to item meta data and the matrices P, U comprise latent variables relating to user personal data. The client is configured to retrieve a local data set x associated with the new user stored on the client; obtain the master model matrices Q_{v*}, U from the server, the master model matrix Q being updated in response to the new item; generate a local model P_{x*} using the local data set x and the master model matrix U; and generate a personalized item recommendation for the new user of the client using the local model P_{x*} and the master model matrix Q_{v*}. This enables that personalized item recommendations may be provided also in a case where, for example, a new user has signed up to the service and a new item is added to the service, and there is no historical data about user-item interactions available.

In one embodiment, the local data set x stored on the client comprises data associated with at least one of a user of the client or a device associated with the user. Hence, no personal data may be sent outside the user's device, and privacy of the personal data of the user may be ensured.

In one embodiment, the data associated with the user comprises at least one of an age, a gender, a location, a device type or demographics of the user. Hence, various data on the user may be utilized for providing the personalized item recommendations without needing to send the data outside a device, such as the client, of the user.

In one embodiment, the item comprises one of a music piece, a video file, an application, an appliance or a commodity. Hence, the personalized item recommendations may be generated for different kinds of items.

According to a fourth aspect, there is provided a server adapted for assisting in generating personalized recommendations of a new item for a user of a client, the server being connectable to a plurality of clients and at least one content provider for assisting in generating personalized item recommendations for a user of the client, the personalized item recommendations being generated using a joint model of integrated multiple data views comprising a user-item interaction matrix R=PQ^{T}, a user data matrix X=UP^{T}, and an item data matrix Y=QV^{T}, wherein the matrices Q, V comprise latent variables relating to item meta data and the matrices P, U comprise latent variables relating to user personal data. The server is configured to generate master model matrices Q, U for assisting in generating personalized item recommendations for users of the clients; transmit the master model matrix Q to the at least one content provider; obtain a gradient matrix dq*ᵥ from the at least one content provider, the gradient matrix dq*ᵥ being obtained in response to a new item obtained by the content provider; update the master model matrix Q based on the gradient matrix dq*ᵥ; and transmit the updated master model matrix Q_{v*} and the master model matrix U to each client to enable generation of personalized recommendations for the user of the client. This enables that personalized item recommendations may be provided for the user of the client. The personalized item recommendations may be provided in a case, where a new item is added to a service or a platform and there may not be any historical data on user-item interactions available. Further, no personal data of the user may need to be transmitted outside the client of the user to the server.

In one embodiment, the server is further configured to transmit the master model matrices Q, U to each client connected with the server; obtain gradient matrices dqₓ and duₓ from each client; aggregate the gradient matrices dqₓ and duₓ obtained from each client to obtain aggregated gradient matrices dq, du; update the master model matrices Q, U based on the aggregated gradient matrices dq, du; transmit the updated master model matrices Q, U to each client; and transmit the updated master model matrix Q to the at least one content provider. This enables that the master model matrices Q, U may be trained with parameter gradients from the plurality of clients. Hence, more accurate personalized item recommendations may be provided.

In one embodiment, the server is further configured to obtain a gradient matrix dqᵥ from the at least one content provider; and aggregate the gradient matrices dqₓ and duₓ obtained from each client and the gradient matrix dqᵥ from the at least one content provider to obtain the aggregated gradient matrices dq, du. This enables that the master model matrices Q, U may be trained with parameter gradients received from the at least one content provider. Hence, more accurate personalized item recommendations may be provided.

According a fifth aspect, there is provided a server adapted for assisting in generating personalized item recommendations for a new user of a client, the server being connectable to a plurality of clients and at least one content provider for assisting in generating personalized item recommendations for a user of the client, the personalized item recommendations being generated using a joint model of integrated multiple data views comprising a user-item interaction matrix R=PQ^{T}, a user data matrix X=UP^{T}, and an item data matrix Y=QV^{T}, wherein the matrices Q, V comprise latent variables relating to item meta data and the matrices P, U comprise latent variables relating to user personal data. The server is configured to generate master model matrices Q, U for assisting in generating personalized item recommendations for users of the clients; detect a new user; transmit the master model matrices Q, U to a client of the new user to enable generation of personalized recommendations for the new user. This may enable providing personalized item recommendations to a new user when there is not any historical data relating to the user available, such as data on previous user-item interactions.

In one embodiment, the server is further configured to transmit the master model matrices Q, U to each client connected with the server; obtain gradient matrices dqₓ and duₓ from each client; obtain a gradient matrix dqᵥ from the at least one content provider; aggregate the gradient matrices dqₓ and duₓ obtained from each client to obtain aggregated gradient matrices dq, du; update the master model matrices Q, U based on the aggregated gradient matrices dq, du; and transmit the updated master model matrices Q, U to each client. This enables that the master model matrices Q, U may be trained with parameter gradients from the plurality of clients. Hence, more accurate personalized item recommendations may be provided.

In one embodiment, the server is further configured to transmit the master model matrix Q to the at least one content provider; and aggregate the gradient matrices dqₓ, duₓ obtained from each client and the gradient matrix dqᵥ from the at least one content provider to obtain the aggregated gradient matrices dq, du. This enables that the master model matrices Q, U may be trained with parameter gradients received from the at least one content provider. Hence, more accurate personalized item recommendations may be provided.

In one embodiment, the server is further configured to transmit the master model matrix Q to the at least one content provider; obtain a gradient matrix dq*ᵥ from the at least one content provider, the gradient matrix dq*ᵥ being obtained in response to the new item obtained by the content provider; update the master model matrix Q based on the gradient matrix dq*ᵥ; and transmit the updated master model matrix Q_{v*} to the client of the new user to enable generation of personalized recommendations for the user of the client. This may enable providing personalized item recommendations to the user of the client relating to new items without any previous user-item interactions. Hence, also new items may be recommended to relevant users as soon as they are added to the service.

In one embodiment, the server is configured to update the master model matrices Q, U in a predetermined interval based on an aggregate of gradient matrices duₓ, dqₓ received from the plurality of clients and gradient matrix dqᵥ from the at least one content provider. This enables that the master model matrices may be updated regularly. Further, the most accurate personalized item recommendations may be provided to the users of the clients.

In one embodiment, the server is configured to update the master model matrices Q, U continuously based on an aggregate of gradient matrices duₓ, dqₓ received from the plurality of clients and gradient matrix dqᵥ from the at least one content provider. This enables that the master model matrices may be continuously trained. Further, the most accurate personalized item recommendations may be provided to the users of the clients.

According to a sixth aspect, there is provided a content provider connectable to a server utilizing master model matrices Q, U for assisting in generating personalized item recommendations for users of a plurality of clients, wherein the personalized item recommendations are generated using a joint model of integrated multiple data views comprising a user-item interaction matrix R=PQ^{T}, a user data matrix X=UP^{T}, and an item data matrix Y=QV^{T}, wherein the matrices Q, V comprise latent variables relating to item meta data and the matrices P, U comprise latent variables relating to user personal data. The content provider is configured to obtain the master model matrix Q from the server; update a local model V using an item metadata y stored on the content provider and the master model matrix Q; calculate a gradient matrix dqᵥ of the master model matrix Q based on the local model V and the item metadata y; transmit the gradient matrix dqᵥ to the server for aggregating dqᵥ with other gradient matrices to enable updating the master model matrix Q by the server; receive a new item comprising item metadata y*; update the local model V using the item metadata y*; compute a gradient matrix dq*ᵥ for the master model matrix Q with respect to the updated local model V; and transmit the gradient matrix dq*ᵥ to the server for updating the master model matrix Q. This enables that the personalized item recommendations may be provided for new items as soon as they are received by the content provider.

In one embodiment, the item comprises at least one of a video file, a music piece, an application, an appliance or a commodity. Hence, the personalized item recommendations may be generated for various kinds of items.

According to a seventh aspect, there is provided a method for generating personalized recommendations of a new item for a user of a client, the client being connectable to a server comprising master model matrices Q, U for distribution to a plurality of clients for generating personalized item recommendations, wherein the personalized item recommendations are generated using a joint model of integrated multiple data views comprising a user-item interaction matrix R=PQ^{T}, a user data matrix X=UP^{T}, and an item data matrix Y=QV^{T}, wherein the matrices Q, V comprise latent variables relating to item meta data and the matrices P, U comprise latent variables relating to user personal data. The method comprises the following operations to be carried out by the client: retrieving a local data set x stored on the client; obtaining an updated master model matrix Q_{v*} from the server, the master model matrix Q being updated in response to a new item; updating a local model P based on the updated master model matrix Q and the local data set x; and generating a personalized recommendation for the new item for the user of the client using the local model P and the updated master model matrix Q_{v*}. This enables that personalized item recommendations may be provided for the user of the client. The personalized item recommendations may be provided in a case, where a new item is added to a service or a platform without any historical data on user-item interactions. Further, no personal data of the user may need to be transmitted outside the client.

In one embodiment, the method further comprises obtaining the master model matrices Q, U from the server; and updating the local model P based on the master model matrices Q, U and the local data set x. Hence, the personalized item recommendation may be generated using latest parameter updates from the master model matrices.

In one embodiment, the method further comprises calculating gradient matrices dqₓ and duₓ of the master model matrices Q, U based on the local data set x and the local model P; transmitting the gradient matrices dqₓ, duₓ to the server for enabling the server to generate aggregated gradient matrices dq, du based on gradient matrices received from the plurality of clients and/or at least one content provider, the aggregated gradient matrices dq, du enabling updating the master model matrices Q, U by the server; obtaining updated master model matrices Q, U from the server; and updating the local model P based on the updated master model matrices Q, U and the local data set x. Hence, that the master model matrices Q, U may be trained with parameter gradients received from the plurality of other clients. This enables that more accurate personalized item recommendations may be provided.

According to an eighth aspect, there is provided a method for generating personalized item recommendations for a new user of a client the client being connectable to a server comprising master model matrices Q, U for distribution to a plurality of clients for generating personalized item recommendations, wherein the personalized item recommendations are generated using a joint model of integrated multiple data views comprising a user-item interaction matrix R=PQ^{T}, a user data matrix X=UP^{T}, and an item data matrix Y=QV^{T}, wherein the matrices Q, V comprise latent variables relating to item meta data and the matrices P, U comprise latent variables relating to user personal data. The method comprises the following operations to be carried out by the client: retrieving a local data set x associated with the new user stored on the client; obtaining the master model matrices Q, U from the server; generating a local model P_{x*} using the local data set x and the master model matrix U; and generating a personalized item recommendation for the new user of the client using the local model P_{x*} and the master model matrix Q. This enables that personalized item recommendations may be provided to a new user of a client. The personalized item recommendations may be provided in a case, for example, when a new user signs up to a service without any historical data on user-item interactions. Further, no personal data of the user may need to be transmitted outside the client.

According to a ninth aspect, there is provided a method for generating personalized recommendations of a new item for a new user of a client, the client being connectable to a server comprising master model matrices Q, U for distribution to a plurality of clients for generating personalized item recommendations, wherein the personalized item recommendations are generated using a joint model of integrated multiple data views comprising a user-item interaction matrix R=PQ^{T}, a user data matrix X=UP^{T}, and an item data matrix Y=QV^{T}, wherein the matrices Q, V comprise latent variables relating to item meta data and the matrices P, U comprise latent variables relating to user personal data. The method comprises the following operations to be carried out by the client: retrieving a local data set x associated with the new user stored on the client; obtaining the master model matrices Q_{v*}, U from the server, the master model matrix Q_{v*} being updated in response to a new item; generating a local model P_{x*} using the local data set x and the master model matrix U; and generating a personalized item recommendation for the user of the client using the local model P_{x*} and the master model matrix Q_{v*}. This enables that personalized item recommendations may be provided also in a case where, for example, a new user has signed up to the service and a new item is added to the service, and there is no historical data about user-item interactions available.

In one embodiment, the local data set x stored on the client comprises data associated with at least one of a user of the client or a device associated with the user. Hence, no personal data may be sent outside the user's device, and privacy of the personal data of the user may be ensured.

In one embodiment, the data associated with the user comprises at least one of an age, a gender, a location, a device type or demographics of the user. Hence, various data on the user may be utilized for providing the personalized item recommendations without needing to send the data outside a device, such as the client, of the user.

In one embodiment, the item comprises one of a music piece, a video file, an application, an appliance or a commodity. Hence, the personalized item recommendations may be generated for different kinds of items.

According to a tenth aspect, there is provided a method for assisting in generating personalized recommendations of a new item for a user of a client, by a server, the server being connectable to a plurality of clients and at least one content provider for assisting in generating personalized item recommendations for a user of the client, the personalized item recommendations being generated using a joint model of integrated multiple data views comprising a user-item interaction matrix R=PQ^{T}, a user data matrix X=UP^{T}, and an item data matrix Y=QV^{T}, wherein the matrices Q, V comprise latent variables relating to item meta data and the matrices P, U comprise latent variables relating to user personal data. The method comprises the following operations to be carried out by the server: generating master model matrices Q, U for assisting in generating personalized item recommendations for users of the clients; transmitting the master model matrix Q to the at least one content provider; obtaining a gradient matrix dq*ᵥ from the at least one content provider, the gradient matrix dq*ᵥ being obtained in response to the new item obtained by the content provider; updating the master model matrix Q based on the gradient matrix dq*ᵥ; and transmitting the updated master model matrix Q_{v*} and the master model matrix U to each client to enable generation of personalized recommendations for the user of the client. This enables that personalized item recommendations may be provided for the user of the client. The personalized item recommendations may be provided in a case, where a new item is added to a service or a platform and there may not be any historical data on user-item interactions available. Further, no personal data of the user may need to be transmitted outside the client of the user to the server.

In one embodiment, the method further comprises transmitting the master model matrices Q, U to each client connected with the server; obtaining gradient matrices dqₓ and duₓ from each client; aggregating the gradient matrices dqₓ and duₓ obtained from each client to obtain aggregated gradient matrices dq, du; updating the master model matrices Q, U based on the aggregated gradient matrices dq, du; transmitting the updated master model matrices Q, U to each client; and transmitting the updated master model matrix Q to the at least one content provider. This enables that the master model matrices Q, U may be trained with parameter gradients from the plurality of clients. Hence, more accurate personalized item recommendations may be provided.

In one embodiment, the method further comprises obtaining a gradient matrix dqᵥ from the at least one content provider; and aggregating the gradient matrices dqₓ and duₓ obtained from each client and the gradient matrix dqᵥ from the at least one content provider to obtain the aggregated gradient matrices dq, du. This enables that the master model matrices Q, U may be trained with parameter gradients received from the at least one content provider. Hence, more accurate personalized item recommendations may be provided.

According to an eleventh aspect, there is provided a method for assisting in generating personalized item recommendations for a new user of a client, by a server, the server being connectable to a plurality of clients and at least one content provider for assisting in generating personalized item recommendations for a user of the client, the personalized item recommendations being generated using a joint model of integrated multiple data views comprising a user-item interaction matrix R=PQ^{T}, a user data matrix X=UP^{T}, and an item data matrix Y=QV^{T}, wherein the matrices Q, V comprise latent variables relating to item meta data and the matrices P, U comprise latent variables relating to user personal data. The method comprises the following operations to be carried out by the server: generating master model matrices Q, U for assisting in generating personalized item recommendations for users of the clients; detecting a new user; and transmitting the master model matrices Q, U to a client of the new user to enable generation of personalized recommendations for the new user. This may enable providing personalized item recommendations to a new user when there is not any historical data relating to the user available, such as data on previous user-item interactions.

In one embodiment, the method further comprises transmitting the master model matrices Q, U to each client connected with the server; obtaining gradient matrices dqₓ and duₓ from each client; aggregating the gradient matrices dqₓ, duₓ obtained from each client to obtain aggregated gradient matrices dq, du; updating the master model matrices Q, U based on the aggregated gradient matrices dq, du; and transmitting the updated master model matrices Q, U to each client. This enables that the master model matrices Q, U may be trained with parameter gradients from the plurality of clients. Hence, more accurate personalized item recommendations may be provided.

In one embodiment, the method further comprises transmitting the master model matrix Q to the at least one content provider; obtaining a gradient matrix dqᵥ from the at least one content provider; and aggregating the gradient matrices dqₓ, duₓ obtained from each client and the gradient matrix dqᵥ from the at least one content provider to obtain the aggregated gradient matrices dq, du. This enables that the master model matrices Q, U may be trained with parameter gradients received from the at least one content provider. Hence, more accurate personalized item recommendations may be provided.

In one embodiment, the method further comprises transmitting the master model matrix Q to the at least one content provider; obtaining a gradient matrix dq*ᵥ from the at least one content provider, the gradient matrix dq*ᵥ being obtained in response to the new item obtained by the content provider; updating the master model matrix Q based on the gradient matrix dq*ᵥ; and transmitting the updated master model matrix Q_{v*} to each client to enable generation of personalized recommendations for the user of the client. This may enable providing personalized item recommendations to the user of the client relating to new items without any previous user-item interactions. Hence, also new items may be recommended to relevant audience as soon as they are added to the service.

In one embodiment, the server is configured to update the master model matrices Q, U in a predetermined interval based on an aggregate of gradient matrices duₓ, dqₓ received from the plurality of clients and gradient matrix dqᵥ from the at least one content provider. This enables that the master model matrices may be updated regularly. Further, the most accurate personalized item recommendations may be provided to the users of the clients.

In one embodiment, the server is configured to update the master model matrices Q, U continuously based on an aggregate of gradient matrices duₓ, dqₓ received from the plurality of clients and gradient matrices dqᵥ from the at least one content provider. This enables, that the master model matrices may be continuously trained. Further, the most accurate personalized item recommendations may be provided to the users of the clients.

According to a twelfth aspect, there is provided a method for providing items to a user of a client, by a content provider, the content provider being connectable to a server utilizing master model matrices Q, U for assisting in generating personalized item recommendations for users of a plurality of clients, wherein the personalized item recommendations are generated using a joint model of integrated multiple data views comprising a user-item interaction matrix R=PQ^{T}, a user data matrix X=UP^{T}, and an item data matrix Y=QV^{T}, wherein the matrices Q, V comprise latent variables relating to item meta data and the matrices P, U comprise latent variables relating to user personal data. The method comprises the following operations to be carried out by the content provider: obtaining the master model matrix Q from the server; updating a local model V using an item metadata y stored on the content provider and the master model matrix Q; calculating a gradient matrix dqᵥ of the master model matrix Q based on the local model V and the item metadata y; transmitting the gradient matrix dqᵥ to the server for aggregating dqᵥ with other gradient matrices to enable updating the master model matrix Q by the server; receiving a new item comprising item metadata y*; updating the local model V using the item metadata y*; computing a gradient matrix dq*ᵥ for the master model matrix Q with respect to the updated local model V; and transmitting the gradient matrix dq*ᵥ to the server for updating the master model matrix Q. This enables that the personalized item recommendations may be provided for new items as soon as they are received by the content provider.

In one embodiment, the items comprise at least one of a video file, a music piece, an application, an appliance or a commodity. Hence, the personalized item recommendations may be generated for various kinds of items.

According to a thirteenth aspect, there is provided a system adapted for generating personalized item recommendations for a user of a client, the system comprising a plurality of clients according to the first, second or third aspect, a server according to the fourth or fifth aspect and at least one content provider according to the sixth aspect. This enables that personalized item recommendations may be provided for the user of the client. Advantageously, the personalized item recommendations may be provided in cold start scenarios, for example, where at least one of a new user signs up to a service or a new item is added to the service, and there is no historical data on previous user-item interactions available. Further, no personal data of the user may need to be transmitted outside the client of the user.

According to a fourteenth aspect, there is provided a computer program comprising program code configured to perform the method of any of the seventh-twelfth aspect.

According to a fifteenth aspect, there is provided a computer-readable medium comprising a computer program comprising program code configured to perform the method of any of the seventh-twelfth aspect.

### BRIEF DESCRIPTION OF THE DRAWINGS

In the following, examples are described in more detail with reference to the attached figures and drawings, in which:

FIG. 1 illustrates a schematic representation of three scenarios for cold-start recommendation generation according to an aspect.

FIG. 2 illustrates a schematic representation of a block diagram of a concept of multi-view matrix factorization according to an aspect.

FIG. 3 illustrates a schematic representation of a flowchart of generating cold-start recommendations for users of clients with a multi-view federated learning system according to an aspect.

FIG. 4 illustrates a schematic representation of a sequence diagram for generating cold-start recommendation of a new item to a user of a client according to an aspect.

FIG. 5 illustrates a schematic representation of a sequence diagram for generating cold-start recommendations to a new user of a client according to an aspect.

FIG. 6 illustrates a schematic representation of a sequence diagram for generating cold-start recommendations of new items to a new user of a client according to an aspect.

FIG. 7 illustrates an example of a device configured to practice one or more example embodiments.

### DETAILED DESCRIPTION

In the following description, reference is made to the accompanying drawings, which form part of the disclosure, and in which are shown, by way of illustration, specific aspects and examples in which the present subject-matter may be placed. It is understood that other aspects may be utilized, and structural or logical changes may be made without departing from the present subject-matter. The following detailed description, therefore, is not to be taken in a limiting sense, as the present subject-matter is defined in the appended claims.

For instance, it is understood that a disclosure in connection with described methods may also hold true for a corresponding devices or systems configured to perform the method and vice versa. For example, if a specific method operation is described, a corresponding device may include a unit or other means to perform the described method operation, even if such unit is not explicitly described or illustrated in the figures. On the other hand, for example, if a specific apparatus is described based on functional units, a corresponding method may include a operation performing the described functionality, even if such operation is not explicitly described or illustrated in the figures. Further, it is understood that the features of the various exemplary aspects described herein may be combined with each other, unless specifically noted otherwise.

A purpose of the solution is to provide a system enabling a so-called cold-start recommendation in a federal learning mode. In the solution, the cold-start recommendations may be provided by federating a multi-view model. Specifically, the multi-view model may be a multi-view factorization model. Further, the solution aims to provide cold-start recommendations without transferring user's personal data out of the user's own device. The solution presented in this disclosure is abbreviated to CFR, a cold-start federated recommendation system.

The federated learning model may refer to a distributed machine learning technique which enables model training on a large amount of decentralized data. In federated learning, an algorithm may be trained across multiple decentralized devices and/or servers may hold local data samples without exchanging their data samples, for example, by uploading their data samples to a centralized server. Hence, the multiple devices and/or servers may build a global master model without sharing local data, such as user personal data.

Cold-start in recommendation systems refers to a situation where a new user and/or a new item enters the system. In the cold-start situation, the recommendation system may not have any history information associated with the new user, for example, about previous user-item interactions. Similarly, there may not be any history information associated to a new item, such as which kind of users have previously liked the item. In addition to the problems associated with the cold-start user and the cold-start item situations, there is also a more problematic recommendation situation, where both a new user and a new item have accessed the system. In the situation, the goal is to identify if the new item should be recommended to the new user, when there is no history associated either with the user or the item.

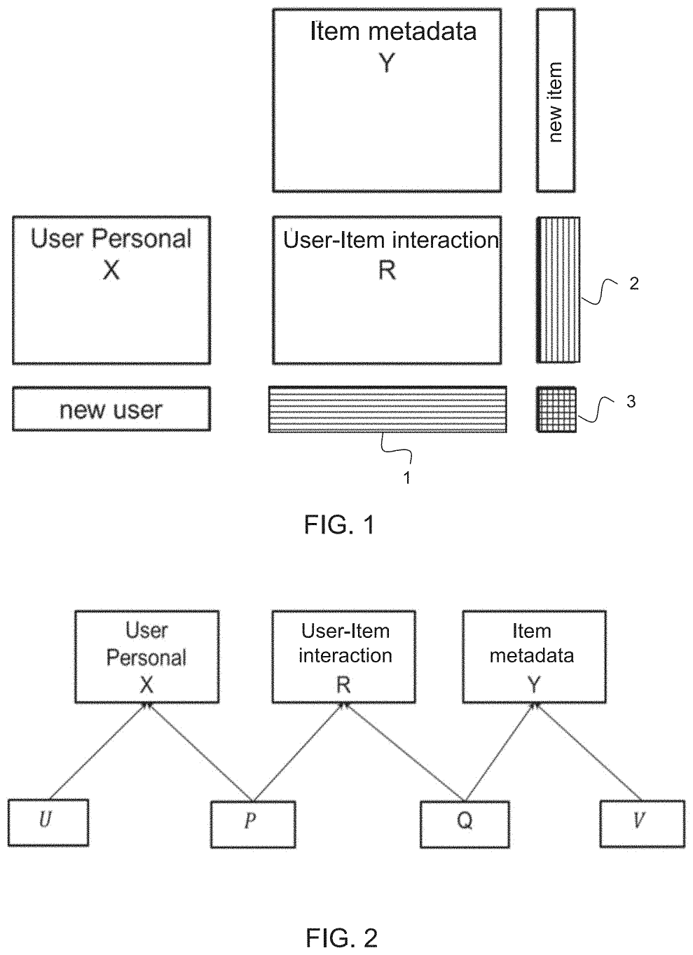

FIG. 1 illustrates all the above three cases of cold-start recommendation. Specifically, given a) user's personal data X such as demographics information comprising at least one of an age, a gender, a device type or other similar user features, b) item metadata Y describing the item such as the actors, directors, producers, composers, artists, language and similar other item features, and c) history of user-item interactions R, CFR may predict user-item interactions for the three cold-start scenarios. The three cold-start scenarios comprise 1) a new user based on his/her personal data, such as an age, a gender, and/or a device type, 2) a new item based on its metadata, and 3) if the new user would like the new item, based on user's personal data and item metadata. These scenarios 1, 2, 3 are illustrated as horizontal lines, vertical lines and a grid of the lines in FIG. 1, respectively.

The CFR system presented in detail from here on may provide a unique federated solution for all of the three cold-start scenarios 1, 2, 3. The CFR may provide recommendations for the different cold-start cases without any of the users' personal data moving out of the users' personal devices by employing the federated learning approach.

In order to make the cold-start recommendations, the CFR may use multi-view matrix factorization. FIG. 2 conceptualizes the learning from multiple data views for generating personalized item recommendations. The different data views may comprise different data sets. With a blend of matrix factorization, latent variables and multi-view machine learning approaches, it may be possible to address several challenging tasks such as generating the recommendations for a new user (cold-start user), the recommendations for new items (cold-start item) and the recommendations for an entirely new user and new item (out-of-matrix prediction). Addressing these tasks may not be effectively possible with any simpler approaches, such as collaborative filtering.

In FIG. 2, there is a user-item interaction data matrix R that denotes user interactions P with items Q. There may be also available user personal data matrix X giving information, for example, on user demographics such as an age, a location and/or a gender, a device type of the user device, and other similar user features U. Moreover, an item metadata matrix Y may be also known comprising information such as actors, directors, producers, languages, and other similar item features V. The multi-view matrix factorization may enable to learn a joint factorization of all the three data matrices X, R, Y. The joint factorization may decompose the observed data into sets of low-dimensional latent factors P, Q, U, V that capture the dependencies between the matrices X, R, Y, as presented in the joint model below:

R˜PQ^{T}

X˜UP^{T}

Y˜QV^{T},

where T is a matrix transpose, R˜PQ^{T} illustrates a collaborative filter and X˜UP^{T} may be deemed as a personalized regression. The joint model may be utilized by the multi-view federated learning system, CFR, for generating personalized item recommendations for users of clients, as further described in the next sections.

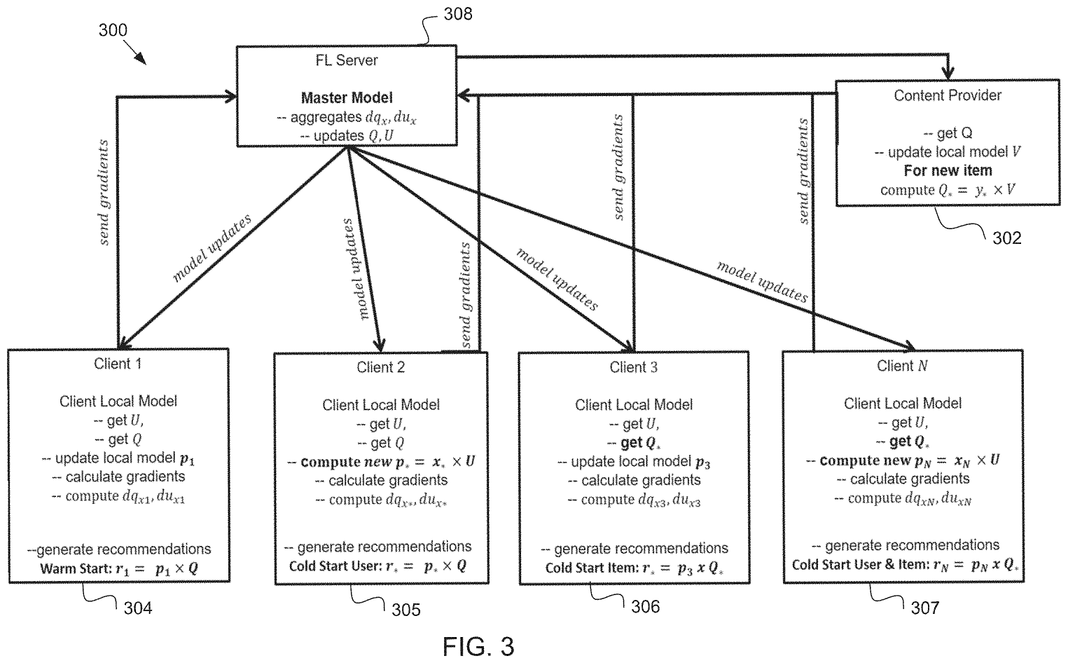

FIG. 3 illustrates a schematic representation of a flowchart of generating cold-start recommendations for users of clients 304, 305, 306, 307 with a multi-view federated learning system 300 according to an aspect. The multi-view federated learning (CFR) system 300 may comprise a federated learning (FL) server 308 coupled with at least one content provider 302 and a plurality of clients 304, 305, 306, 307.

The cold-start recommendations may be provided by federating a multi-view model, such as the multi-view matrix factorization as shown in FIG. 2, and the associated joint model presented above. For example, in analogy with FIG. 1, for a new item, such as a newly released video, the server 308 may assist in predicting the user-item interactions r associated with the new item. Similarly, if a new user enters the system, the client 305, 307 may use the multi-view joint model to make cold-start recommendations on which items the user of the client 305, 307 is likely to be interested in, even though there is zero historical data associated with the user. In addition, the solution may allow predicting the complex cold-start prediction problems, i.e. when a new user signs up and new items are released, the joint model may be able to make predictions with zero historical user-item interaction information for either the user or item.

The generation of recommendations may be based on having a machine learning based master model matrices Q, U on the centralized server 300. The master model matrices Q, U may be distributed to each client 304, 305, 306, 307. The clients 304, 305, 306, 307 may retrieve from their memories individual local data sets x associated with the user of each client 304, 305, 306, 307. Each client 304, 305, 306, 307 may comprise a local model P, which is updated based on the obtained master model matrices Q, U and the local data set x. Also, the master model matrices Q, U may be updated locally on each client 304, 305, 306, 307 based on the local data set x stored on the client 304, 305, 306, 307. After updating the local model P, each client 304, 305, 306, 307 may calculate gradient matrices dqₓ and duₓ of the respective master model matrices Q, U based on the local data set x and the local model P. The gradient matrices dqₓ and duₓ may comprise updated parameter information of the master model matrices Q, U. The gradient matrices dqₓ and duₓ may be transferred back to the server 308. At the server 308, the gradient matrices dqₓ and duₓ may be aggregated across the users, i.e. clients 304, 305, 306, 307, to generate new updated master models Q, U. The aggregate of the gradient matrices may further comprise a gradient matrix dqᵥ received from the at least one content provider 302. The master model matrices Q, U updated by the server 308 may be transmitted to each client 304, 305, 306, 307 to further update the local model P based on the updated local model matrices Q, U and the local data set x. Each client 304, 305, 306, 307 may then generate a personalized item recommendation for the user of the client using the updated local model P and the updated master model matrix Q. The generation of the personalized item recommendation may be presented as r₁=p₁×Q, wherein the subscript 1 denotes the client 1 among clients 1 . . . N.

In addition, the clients 304, 305, 306, 307 may obtain an updated master model matrix Q from the server 308 when the master model matrix Q has been updated in response to a new item. Each client 304, 305, 306, 307 may use the updated master model matrix Q_{v*} associated with the new item and the local data set x to update the local model P. Each client 304, 305, 306, 307 may generate a personalized item recommendation for the user of the client 304, 305, 306, 307 using the local model P and the updated master model matrix Q_{v*}. Hence, personalized item recommendations may be generated for new items as soon as they are added to the service.

A new user may enter the system 300, for example, when a new client 305, 307 is coupled with the server 308 or a new user signs up to a service utilizing the system 300 with a client 305, 307 already coupled with the server 308. For generating personalized item recommendations for the new user, the client 305, 307 may retrieve a local data set x associated with the new user stored on the client 305, 307. The client 305, 307 may obtain the master model matrices Q, U from the server 308 in response to the server 308 detecting the new user. A local model P may be generated on the client 305, 307 using the master model matrix U and the local data set x. Further, the personalized item recommendation may be generated for the new user by the client 305, 307 using the local model P and the master model matrix Q. The generation of the personalized item recommendation for the new user may be presented as r_{N}=p_{N}×Q, wherein the subscript N denotes a client N.

The master model matrices Q, U stored locally on the client 304, 305, 306, 307 may use the local data set x for inference. Only parameter updates associated with the user may be transmitted to the server 308. Hence, the local data set x may reside only at the client 304, 305, 306, 307. Therefore, the solution may ensure privacy protection. The local data set x may comprise, for example, data associated with at least one of the user of the client 304, 305, 306, 307 or a device associated with the user.

The master model matrix Q may be also transmitted to the at least one content provider 302. The at least one content provider 302 may provide items, such as music pieces, video files, applications, appliances, or commodities to the users of the clients 304, 305, 306, 307. The at least one content provider 302 may update its local model V based on item metadata y and the received master model matrix Q. The item metadata y may be stored on the content provider. The item metadata y may comprise a data set of metadata associated with all the items stored on the content provider 302. The content provider 302 may calculate a gradient matrix dqᵥ of the master model matrix Q based on the local model V and the item metadata y. Further, the content provider 302 may transmit the gradient matrix dqᵥ to the server 308 for aggregating dqᵥ with other gradient matrices duₓ, dqₓ to enable updating the master model matrix Q by the server 308. Further, when a new item is obtained by the content provider 302, the content provider 302 may update the local model V using item metadata y* of the new item. The content provider 302 may then compute a gradient matrix dq*ᵥ of the master model matrix Q with respect to the updated local model V, and transmit the gradient matrix dq*ᵥ to the server 308. The server 308 may then use the gradient matrix dq*ᵥ to update the master model Q. In case of a personalized recommendation for the new item, the generation of personalized item recommendation may be presented as r*=p×q*T, wherein the * denotes the new item and q* comprises the master model Q updated with respect the updated local model V and the item metadata y*. The local model P may be a local model matrix.

In an embodiment, the server 308 may be configured to detect the new item. For example, the server 308 may have a service which detects whether a new item is added by the content provider 302. Alternatively, when a new item is added, the content provider 302 may itself notify the server 308. In response to detecting the new item, the server 308 may update the master model matrix Q. The server 308 may then transmit the updated master model matrix Q to the at least one content provider 302, for example, to enable further updates of the master model matrix Q based on the item metadata y* of the new item stored on the content provider 302.

Hence, the system 300 may enable updating the joint model in an iterative manner. The model may be trained continuously or in intervals such that the most accurate recommendations as possible may be provided for new users and items. For example, the server 308 may be configured to update the master model matrices Q, U in a predetermined interval based on the aggregate of gradient matrices duₓ, dqₓ received from the plurality of clients 304, 305, 306, 307 and the gradient matrix dqᵥ from the at least one content provider 302. In another example embodiment, the server 308 may be configured to update the master model matrices Q, U continuously based on the aggregate of gradient matrices duₓ, dqₓ received from the plurality of clients 304, 305, 306, 307 and the gradient matrix dqᵥ from the at least one content provider 302. The updated master model matrices Q, U may be then transferred by the server 308 to each client 304, 305, 306, 307 for enabling generating personalized item recommendations for the user of the client 304, 305, 306, 307. Further, the updated master model matrix Q may be transferred by the server 308 to the at least one content provider 302 for further assisting in generating the personalized item recommendations.

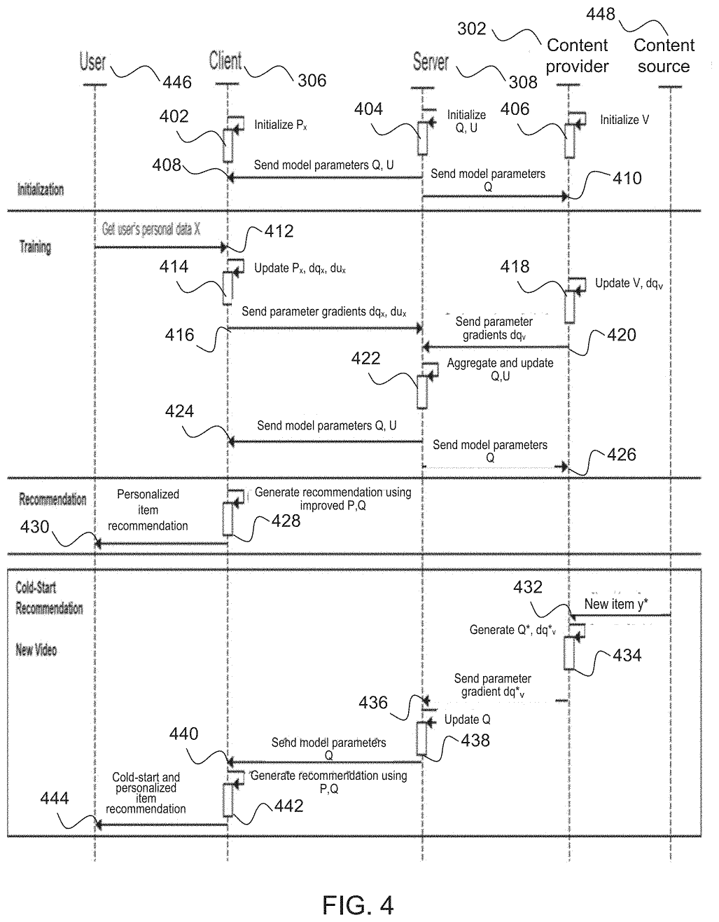

FIG. 4 illustrates a schematic representation of a sequence diagram for generating cold-start recommendation of a new item to a user 446 of a client 304, 305, 306, 307 according to an aspect. The cold-start recommendations may be generated with the system 300 illustrated in FIG. 3. The processes in FIG. 4 takes place between the server 308, the single client 306 and a single content provider 302 for clarity.

When the system 300 is initialized, a local model P may be generated on the client 306 at 402. In addition, at 404, master model matrices Q, U may be generated at the server 308. Further, at 406, a local model V may be generated at the content provider 302. The local models P, V and the global master model matrices Q, U may be used to form a multi-view joint model for generating the personalized item recommendations the user 446 of the client 306. For example, each time a new client 306 (the user 446) signs up to a service utilizing the cold-start recommendation system 300, the local model P may be initialized on the client 306 associated with the user 446. The new user 446 may be detected by the server 308 when the client 306 connects with the server 308. In response, the server 308 may transmit parameters of the master model matrices Q, U to the client 306 at 408. Further, the server 308 may transmit parameters of the master model matrix Q to the content provider 302 at 410.

The master model matrices Q, U may be trained based on parameter gradients dqₓ, duₓ, dqᵥ received from the client 306 and the content provider 302 by the server 308, as described next in detail.

After the client 306 has obtained the master model matrices Q, U from the server 308, and at 414 the client 306 may perform computations to update its local model P. The client 306 may update its local model P based on the master model U and a local data set x retrieved by the client 306 at the operation 412, for example, from its memory. The local data set x may comprise personal data X received from the user 446. The local data x set may comprise data associated with at least one of the user 446 of the client 306 or a device associated with the user 446. The data associated with the user 446 may comprise at least one of an age, a gender, a location, a device type or demographics of the user 446. The client 306 may further calculate gradient matrices dqₓ and duₓ of the master model matrices Q, U based on the local data set x and the local model P. The client 306 may then transmit at 416 the gradient matrices dqₓ, duₓ to the server 308.

At 418, the content provider 302 may perform computations to update its local model V and the master model matrix Q. The content provider 302 may update its local model V based on the received global model matrix Q and item metadata y stored on the content provider 302. Further, at 418, the content provider 302 may compute a gradient matrix dqᵥ of the master model matrix Q with respect to the local model V. Thereafter, the content provider 302 may proceed to 420 and transmit the gradient matrix dqₓ to the server 308 for updating at least the master model matrix Q.

At 422, the gradient matrices dqₓ, duₓ, dqᵥ may be aggregated by the server 308 into gradient matrices du, dq. The aggregated gradient matrices du, dq may further comprise gradient matrices received from a plurality of other clients and other content providers connected to the server 308. The server 308 may use the aggregated gradient matrices dq, du to update the master model matrices Q, U. After updating at 422, the server 308 may transmit at 424 the updated master model matrices Q, U to the client 306. The server 308 may also send at 426 the updated master model matrix Q to the content provider 302.

The client 306 may use the obtained updated master model matrix Q and the local data set x to further update the local model P. The client 306 may use the improved local model P and the updated master model Q to generate 428 a personalized item recommendation to the user 446 of the client 306. At 430, the client 306 may provide the personalized item recommendation to the user 446.

In FIG. 4, operations 402-430 illustrate initialization, training and recommendation phases for generating personalized item recommendations in the system 300. The next section describes how the system 300 may be used for providing cold-start recommendations of new items added to the system 300.

At 432, the content provider receives a new item comprising item metadata y*. The item may be, for example, a video file, a piece of music, an application, an appliance or a commodity. The metadata y* may comprise information associated with the item, for example, actors, directors, producers, languages, and other item features. The item metadata y* may be received from a content source 448, which may be, for example, another user or content provider. In response to receiving the new item, the content provider 302 may update the local model V using the item metadata y*. The content provider 302 may generate an updated master model matrix Q* based on the new item metadata y* and the obtained master model matrix Q. Further, the content provider 302 may compute at 434 a gradient matrix dq*ᵥ for the master model matrix Q* with respect to the updated local model V. Thereafter, the content provider 302 may transmit at 436 the gradient matrix dq*ᵥ to the server 308. At 438 the server 308 may update the master model matrix Q based on the gradient matrix dq*ᵥ received from the content provider 302. The server 308 may transmit at 440 the updated master model matrix Q to the client 306. At 442 the client 306 may use the received updated master model matrix Q and the local model P to generate a personalized item recommendation to the user 446 of the client 306. Finally, the client 306 may provide the personalized item recommendation to the user 446 at 444. The recommendations may be provided to the user 446, for example, via a display coupled to the client 306.

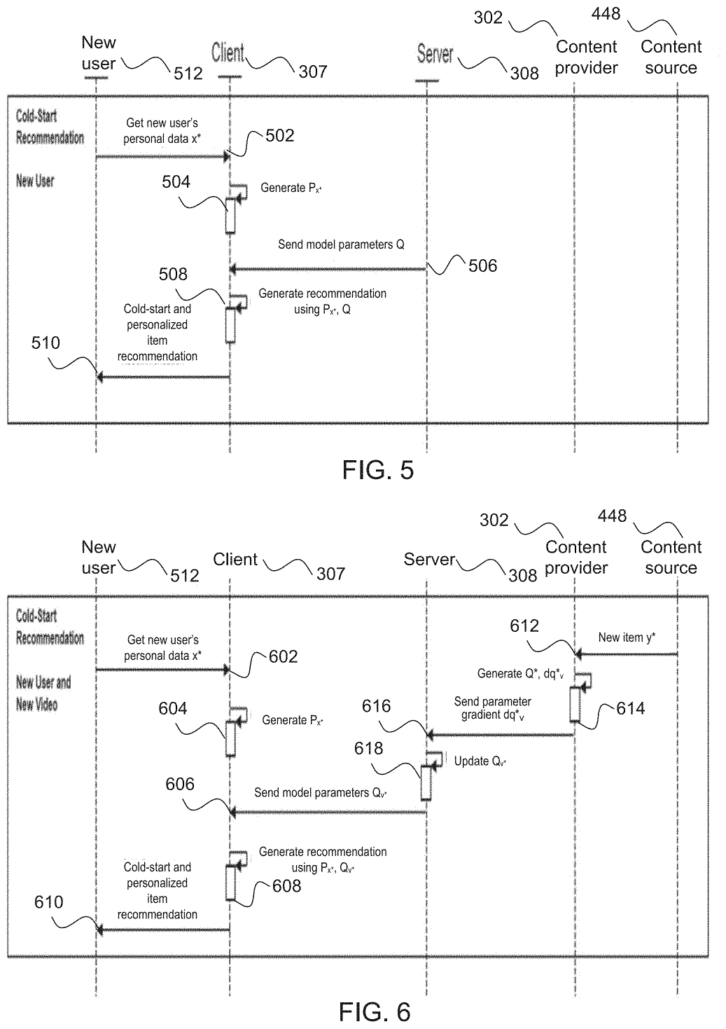

FIG. 5 illustrates a schematic representation of a sequence diagram for generating cold-start recommendations to a new user 512 of a client 307 according to an aspect.

The joint model used in generating the personalized item recommendations may be previously trained as illustrated in FIG. 4 at operations 412-426. The server 308 may be configured to transmit the trained master model matrices Q, U to the client 307 at 506 in response to the server 308 detecting a new user 512.

When the new user 512 has, for example, joined a service hosted by the server 308 by using his client 307, the client 307 may retrieve a local data set x* stored on the client at 502. The local data x* set may comprise data associated with at least one of the user 512 of the client 307 or a device associated with the user 512. At 504 a new local model P_{x*} may be generated by the client device 307 using the local data set x* and an updated master model matrix U. The updated master model matrix U may be the latest version of the master model matrix U available at the server 308 and obtained by the client 307. After an updated master model matrix Q is obtained by the client 307 from the server 308, a personalized item recommendation for the new user 512 may be generated at 508 using the local model P_{x*} and the updated master model matrix Q. The updated master model matrix Q may be the latest version of the master model matrix Q available at the server 308. At 510, the generated personalized item recommendation may be provided to the new user 512 by the client 307. Hence, the personalized item recommendation may be provided to the new user 512 without having any history information associated with the user 512. Further, no personal data of the user 512 may need to be sent outside the client 307.

FIG. 6 illustrates a schematic representation of a sequence diagram for generating cold-start recommendations of new items to a new user 512 of a client 307 according to an aspect.

The joint model used in generating the personalized item recommendations may be previously trained as illustrated in FIG. 4 at operations 412-426. Further, operations 602-604 in FIG. 6 correspond to operations 502-504 of FIG. 5.

At 612, a new item comprising item metadata y* is received by the content provider 302, for example, from a content source 448. The new item may comprise, for example, one of a music piece, a video file, an application, an appliance or a commodity. The content provider 302 may update a local model V using the item metadata y* at 614. Simultaneously, the content provider 302 may generate an updated version Q* of the master model matrix Q. Further, at 614 the content provider 302 may compute a gradient matrix dq*ᵥ for the master model matrix Q* with respect to the updated local model V. The gradient matrix dq*ᵥ may be transmitted by the content provider 302 at 616 to the server 308 for updating the master model matrix Q.

After the gradient matrix dq*ᵥ is obtained by the server 308 from the content provider 302, the server 308 may update the master model matrix Q based on the gradient matrix dq*ᵥ at operation 618. At 606 the server 308 may transmit the updated master model matrix Q_{v*} to the client 307 to enable generation of personalized recommendations of the new item for the new user 512 of the client 307. At 608 the client 307 may generate the personalized item recommendation using the local model PX* and the updated master model matrix Q_{v*}. At 610, the personalized item recommendation may be provided to the new user 512 of the client 307, for example, via a display.

The multi-view matrix factorization model may allow predicting recommendations for new users and items, along with supporting traditional warm-start predictions for existing users and items with known history information. The cold-start recommendation tasks associated to generating recommendations for new users and/or new items may not be possible with standard collaborative filter models. The cold-start recommendation tasks may require the side-information sources to be used to predict the recommendations. The systematic integration of the side-information sources, such as the user personal data X as well as the item metadata Y illustrated in FIG. 2, may make it possible to learn the joint model as presented above. The joint model may be used to generate recommendations for completely new users (cold-start users), unseen or unused items (cold-start items) and new users-new items (cold-start users and items) collectively. For instance, the cold-start recommendation may be used to attract new users, such as new customers. Data driven personalized recommendations are better than random or top list recommendations, which may be a useful tool, for example, for advertising. The cold-start items may be utilized to target new items, such as videos or applications, to more relevant audience/users forming a candidate set for the new items.

An advantage of at least some embodiments discussed above compared to the simpler approaches may be the ability to make cold-start recommendations on a user's device without the need to transfer user data back to a centralized server.

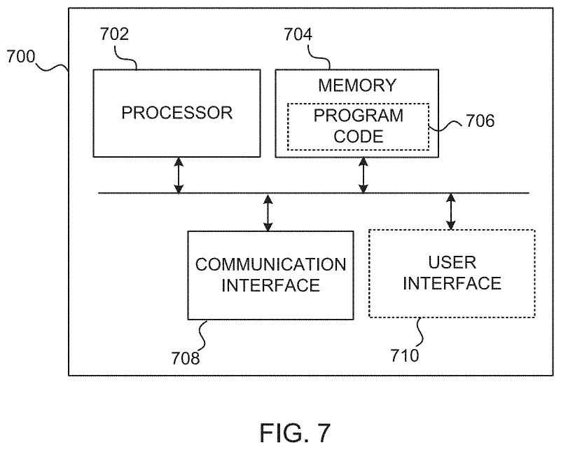

FIG. 7 illustrates an embodiment of a device 700, for example, a client device or a network server, configured to practice one or more example embodiments. The device 700 may comprise at least one processor 702. The at least one processor 702 may comprise, for example, one or more of various processing devices, for example, a co-processor, a microprocessor, a controller, a digital signal processor (DSP), processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like.

The device 700 may further comprise at least one memory 704. The at least one memory 704 may be configured to store, for example, computer program code or the like, for example, operating system software and application software. The at least one memory 704 may comprise one or more volatile memory devices, one or more non-volatile memory devices, and/or a combination thereof. For example, the at least one memory 704 may be embodied as magnetic storage devices (such as hard disk drives, floppy disks, magnetic tapes, etc.), optical magnetic storage devices, or semiconductor memories (such as mask read-only memory (ROM), programmable ROM (PROM), erasable PROM (EPROM), flash ROM, random access memory (RAM), etc.).

The device 700 may further comprise a communication interface 708 configured to enable the device 700 to transmit and/or receive information. The communication interface 708 may be configured to provide at least one wireless radio connection, such as a 3GPP mobile broadband connection (e.g. 3G, 4G, 5G). Alternatively, or additionally, the communication interface 208 may be configured to provide one or more other type of connections, for example, a wireless local area network (WLAN) connection such as for example standardized by IEEE 802.11 series or Wi-Fi alliance; a short range wireless network connection, for example, a Bluetooth, NFC near-field communication (NFC), or RFID connection; a wired connection, for example, a local area network (LAN) connection, a universal serial bus (USB) connection, a high-definition multimedia interface (HDMI), or an optical network connection; or a wired Internet connection. The communication interface 708 may comprise, or be configured to be coupled to, at least one antenna to transmit and/or receive radio frequency signals. One or more of the various types of connections may be also implemented as separate communication interfaces, which may be coupled to or configured to be coupled to a plurality of antennas.

The device 700 may further comprise a user interface 710 comprising or being configured to be coupled to an input device and/or an output device. The input device may take various forms such as for example a keyboard, a touch screen, and/or one or more embedded control buttons. The output device may for example comprise at least one display, speaker, vibration motor, olfactory device, or the like.

When the device 700 is configured to implement some functionality, some component and/or components of the device 700, for example, the at least one processor and/or the memory, may be configured to implement this functionality. Furthermore, when the at least one processor is configured to implement some functionality, this functionality may be implemented using program code 706 comprised, for example, in the at least one memory 704.

The functionality described herein may be performed, at least in part, by one or more computer program product components such as software components. According to an embodiment, the device 700 comprises a processor or processor circuitry, such as for example a microcontroller, configured by the program code, when executed, to execute the embodiments of the operations and functionality described herein. Alternatively, or in addition, the functionality described herein can be performed, at least in part, by one or more hardware logic components. For example, and without limitation, illustrative types of hardware logic components that can be used include Field-programmable Gate Arrays (FPGAs), application-specific Integrated Circuits (ASICs), application-specific Standard Products (ASSPs), System-on-a-chip systems (SOCs), Complex Programmable Logic Devices (CPLDs), Graphics Processing Units (GPUs).

The device 700 comprises means for performing at least one method described herein. In one example, the means comprises at least one processor and at least one memory including computer program code, the at least one memory and the computer code configured to, with the at least one processor, cause the device at least to perform the method.

Although the device 700 is illustrated as a single device it is appreciated that, wherever applicable, functions of the device 700 may be distributed to a plurality of devices, for example, to implement example embodiments as a cloud computing service.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

It will be understood that the benefits and advantages described above may relate to one example or may relate to several examples. The examples are not limited to those that solve any or all of the stated problems or those that have any or all of the stated benefits and advantages. It will further be understood that reference to ‘an’ item may refer to one or more of those items.

The operations of the methods described herein may be carried out in any suitable order, or simultaneously where appropriate. Additionally, individual blocks may be deleted from any of the methods without departing from the spirit and scope of the subject matter described herein. Aspects of any of the examples described above may be combined with aspects of any of the other examples described to form further examples without losing the effect sought.

The term ‘comprising’ is used herein to mean including the method, blocks or elements identified, but that such blocks or elements do not comprise an exclusive list and a method or apparatus may contain additional blocks or elements.

Although the disclosure and its advantages have been described in detail with reference to specific features and embodiments thereof, it is evident that various changes, modifications, substitutions, combinations and alterations can be made thereto without departing from the spirit and scope as defined by the appended claims. The specification and drawings are, accordingly, to be regarded simply as an illustration as defined by the appended claims, and are contemplated to cover any and all modifications, variations, combinations or equivalents that fall within the scope of the present subject-matter.

1. A client adapted for generating personalized recommendations of a new item for a user of the client, the client being configured to:
retrieve a local data set x stored on the client, wherein the client being connectable to a server comprising master model matrices Q, U for distribution to a plurality of clients for generating personalized item recommendations, wherein the personalized item recommendations are generated using a joint model of integrated multiple data views comprising a user-item interaction matrix R=PQ^{T}, a user data matrix X=UP^{T}, and an item data matrix Y=QV^{T}, wherein the matrices Q, V comprise latent variables relating to item meta data and the matrices P, U comprise latent variables relating to user personal data;
obtain an updated master model matrix Q_{v*} from the server, the master model matrix Q being updated to be the updated master model matrix Q_{v*} in response to a new item;
update a local model P based on the updated master model matrix Q_{v*} and the local data set x; and
generate a personalized recommendation for the new item for the user of the client using the local model P and the updated master model matrix Q_{v*}.

2. The client of claim 1, further configured to:
obtain the master model matrices Q, U from the server; and
update the local model P based on the master model matrices Q, U and the local data set x.

3. The client of claim 2, further configured to:
calculate gradient matrices dqₓ, duₓ of the master model matrices Q, U based on the local data set x and the local model P;
transmit the gradient matrices dqₓ, duₓ to the server for enabling the server to generate aggregated gradient matrices dq, du based on gradient matrices received from the plurality of clients and/or at least one content provider, the aggregated gradient matrices dq, du enabling updating the master model matrices Q, U by the server;
obtain updated master model matrices Q, U from the server; and
update the local model P based on the updated master model matrices Q, U and the local data set x.

4. A client adapted for generating personalized item recommendations for a new user of the client, the client being configured to:
retrieve a local data set x associated with the new user stored on the client, wherein the client being connectable to a server comprising master model matrices Q, U for distribution to a plurality of clients for generating personalized item recommendations, wherein the personalized item recommendations are generated using a joint model of integrated multiple data views comprising a user-item interaction matrix R=PQ^{T}, a user data matrix X=UP^{T}, and an item data matrix Y=QV^{T}, wherein the matrices Q, V comprise latent variables relating to item meta data and the matrices P, U comprise latent variables relating to user personal data;
obtain the master model matrices Q, U from the server;
generate a local model P_{x*} using the local data set x and the master model matrix U; and
generate a personalized item recommendation for the new user of the client using the local model P_{x*} and the master model matrix Q.

5. A client adapted for generating personalized recommendations of a new item for a new user of the client, the client being configured to:
retrieve a local data set x associated with the new user stored on the client (307), wherein the client being connectable to a server comprising master model matrices Q, U for distribution to a plurality of clients for generating personalized item recommendations, wherein the personalized item recommendations are generated using a joint model of integrated multiple data views comprising a user-item interaction matrix R=PQ^{T}, a user data matrix X=UP^{T}, and an item data matrix Y=QV^{T}, wherein the matrices Q, V comprise latent variables relating to item meta data and the matrices P, U comprise latent variables relating to user personal data;
obtain the master model matrices Q_{v*}, U from the server, the master model matrix Q being updated to be the master model matrix Q_{v*} in response to the new item;
generate a local model P_{x*} using the local data set x and the master model matrix U; and generate a personalized item recommendation for the new user of the client using the local model P_{x*} and the master model matrix Q_{v*}.

6. The client of claim 5, wherein the local data set x stored on the client comprises data associated with at least one of a user of the client or a device associated with the user.

7. The client of claim 6, wherein the data associated with the user comprises at least one of an age, a gender, a location, a device type or demographics of the user.

8. The client of claim 5, wherein the item comprises one of a music piece, a video file, an application, an appliance or a commodity.

9. A system adapted for generating personalized item recommendations for a user of a client, the system comprising
a plurality of clients, each client of the plurality of clients being configured to:
retrieve a local data set x stored on the client, wherein each client being connectable to a server comprising master model matrices Q, U for distribution to a plurality of clients for generating personalized item recommendations, wherein the personalized item recommendations are generated using a joint model of integrated multiple data views comprising a user-item interaction matrix R=PQT, a user data matrix X=UPT, and an item data matrix Y=QVT, wherein the matrices Q, V comprise latent variables relating to item meta data and the matrices P, U comprise latent variables relating to user personal data;
obtain an updated master model matrix Qv* from the server (308), the master model matrix Q being updated in response to a new item;
update a local model P based on the updated master model matrix Qv* and the local data set x; and
generate a personalized recommendation for the new item for the user (306) of the client using the local model P and the updated master model matrix Qv*; and
a server being connectable to the plurality of clients and at least one content provider for assisting in generating personalized item recommendations for a user of a client of the plurality of clients, wherein the at least one content provider being connectable to the server utilizing master model matrices Q, U for assisting in generating the personalized item recommendations for users of the plurality of clients.

10. The system of claim 9, wherein the server being configured to:
generate master model matrices Q, U for assisting in generating personalized item recommendations for users of the plurality of clients;
transmit the master model matrix Q to the at least one content provider;
obtain a gradient matrix dq*ᵥ from the at least one content provider, the gradient matrix dq*ᵥ being obtained in response to a new item obtained by the content provider;
update the master model matrix Q to be an updated master model matrix Q_{v*} based on the gradient matrix dq*ᵥ; and
transmit the updated master model matrix Q_{v*} and the master model matrix U to each client to enable generation of personalized recommendations for the user of the client).

11. The system of claim 9, wherein the server being further configured to:
generate master model matrices Q, U for assisting in generating personalized item recommendations for users of the clients;
detect a new user; and
transmit the master model matrices Q, U to a client of the new user to enable generation of personalized recommendations for the new user.

12. The system of claim 9, wherein the content provider being configured to:
obtain the master model matrix Q from the server;
update a local model V using an item metadata y stored on the content provider and the master model matrix Q;
calculate a gradient matrix dqᵥ of the master model matrix Q based on the local model V and the item metadata y;
transmit the gradient matrix dqᵥ to the server for aggregating dqᵥ with other gradient matrices to enable updating the master model matrix Q by the server;
receive a new item comprising item metadata y*;
update the local model V using the item metadata y*;
compute a gradient matrix dq*ᵥ for the master model matrix Q with respect to the updated local model V; and
transmit the gradient matrix dq*ᵥ to the server for updating the master model matrix Q.
